(19) United States
(12) Patent Application Publication
(10) Pub. No.: US 2009/0059751 A1
(43) Pub. Date: Mar. 5, 2009

(54) OPTICAL DISC APPARATUS AND DATA RECORDING/REPRODUCING APPARATUS

(76) Inventors: Masakazu Ikeda, Odawara (JP); Osamu Kawamae, Kawasaki (JP); Yutaka Nagai, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/200,957

(22) Filed: Aug. 29, 2008

(30) Foreign Application Priority Data
Aug. 29, 2007 (JP) 2007-222022

(51) Int. Cl. G11B 20/18

(52) U.S. Cl. 369/53.17; G9B/20.046

(57) ABSTRACT

A recording/reproducing apparatus capable of encrypting bus data to a host has a bus encryption circuit and controls the access to a memory. Encryption of data between the recording/reproducing apparatus and the host can be achieved to assure protection of data and contents recorded on an optical disc.

### INCORPORATION BY REFERENCE

The present application claims priority from Japanese application JP 2007-222022 filed on Aug. 29, 2007, the content of which is hereby incorporated by reference into this application.

### BACKGROUND OF THE INVENTION

The present invention relates to an optical disc apparatus and a data recording/reproducing apparatus.

Patent Document 1 discloses at its FIG. 5 an example of data format of a Blu-ray disc and gives in line 18 on page 16 a description reading “32 selectors are formed of user data of 32 frames having 2K (2048) bytes per frame and user control data of 32 frames having 18 bytes per frame.”, gives in line 12 on page 17 a description reading “By adding parities associated with 32 rows, respectively, to a data block of 216 rows and 304 columns formed from a scramble data frame, an LDC block is formed. From the LDC block, an LDC cluster of 152 rows and 496 columns is formed.”, gives in line 2 on page 19 a description reading “an access block of 24 columns×30 rows is formed from user control data of 32×18 bytes on the basis of physical addresses. The access block is added with parities on 32 rows, forming a BIS block. The BIS block is sorted to BIS clusters of 3 columns×496 rows.”, and gives in line 7 on page 19 a description reading “In the BIS cluster, three one-column BIS columns are filled among the LDC columns, respectively, forming ECC clusters of 155 columns×496 rows. From the ECC clusters, physical clusters are formed on the basis of 42 combinations of data of 45-channel bits and control data of 1-channel bit and are recorded on an optical disc.” An example of constructing the recording/reproduction based on the data format as above is disclosed in, for example, FIG. 1 of Patent Document 2 by giving in a sub-paragraph (0004) a description reading “A modem unit has a modem circuit, an error correction process circuit and a host I/F circuit and these circuits are connected to a memory through a switching circuit to perform a process of inputting/outputting information between a host and an optical pickup.”

Furthermore, specifications called AACS (Advanced Access Content System) are adopted as standards for protection of copy of video contents in Blu-ray disc and Non-Patent Document 1 describes in section 3.7 a Bus Encryption Flag, indicating a tendency towards encryption of data in a unit of sector in a bus interface between an optical disc drive and a PC host.

### [Patent Document 1] W02004/046936

### [Patent Document 2] JP-A-2007-59001

### [Non-Patent Document 1] AACS Specification Blu-ray Disc Pre-recorded Book Rev 0.912

### SUMMARY OF THE INVENTION

In order to execute the technique disclosed in Non-Patent Document 1 for subjecting data to encryption and inputting/outputting the encrypted data, there needs, apart from the construction shown in Patent Document 2 mentioned in connection with the related arts, a different construction using a separate memory for encryption of data.

An object of the present invention is to easily perform the bus encryption of buses in an interface to a host and the inputting/outputting to/from the host.

To accomplish the above object, a recording/reproducing apparatus is constructed having a bus encryption circuit so as to control the access using a single memory.

According to the present invention, the bus encryption in the interface to the host and the inputting/outputting to/from the host can be achieved with ease.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing the construction of a data recording/reproducing apparatus according to a first embodiment of this invention.

FIG. 2A is a RAM access timing diagram in the mode of recording in the first embodiment of the invention.

FIG. 2B is a diagram showing a RAM access timing in the mode of reproduction in the first embodiment of the invention.

FIG. 3 is a block diagram showing the construction of a data recording/reproducing apparatus according to a second embodiment of the invention.

FIG. 4A is a RAM access timing diagram in the recoding mode in the second embodiment of the invention.

FIG. 4B is a diagram showing a RAM access timing in the reproduction mode in the second embodiment of the invention.

FIG. 5 is a block diagram showing the construction of a data recording/reproducing apparatus according to a third embodiment of the invention.

FIG. 6A is a RAM access timing diagram in the recoding mode in the third embodiment of the invention.

FIG. 6B is a diagram showing a RAM access timing in the reproduction mode in the third embodiment of the invention.

FIG. 7 is a detailed diagram 1 of a bus encryption circuit in the third embodiment of the invention.

FIG. 8 is a detailed diagram 2 of the bus encryption circuit in the third embodiment of the invention.

### DESCRIPTION OF THE EMBODIMENTS

Embodiments of the present invention will now be described with reference to the accompanying drawings.

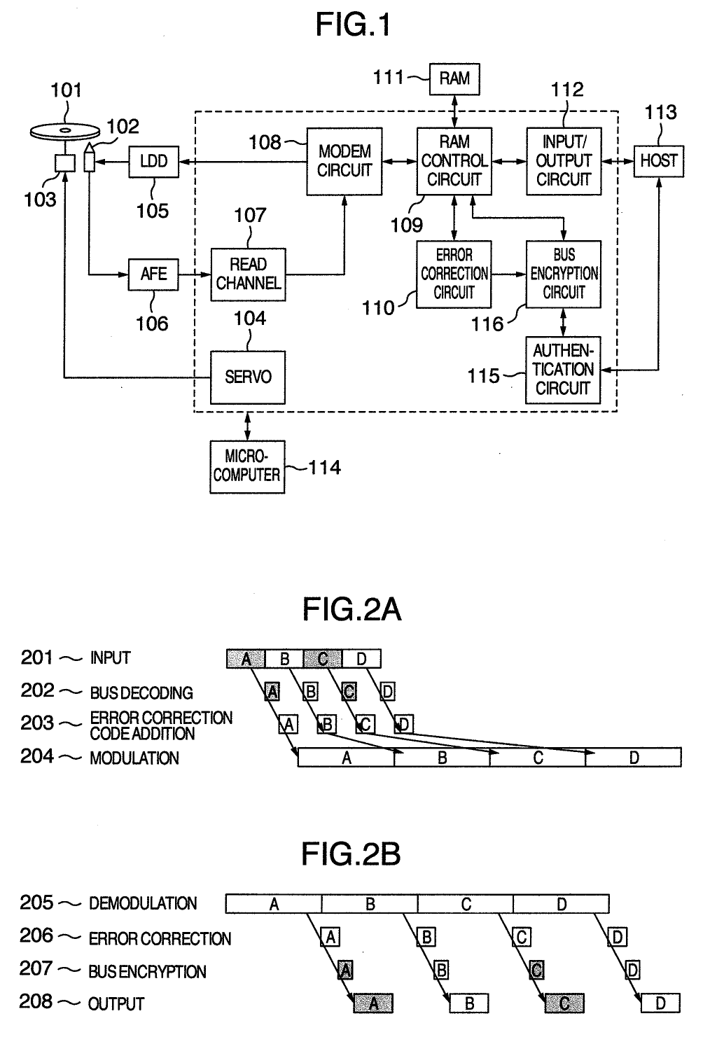

Referring to FIG. 1, a data recording/reproducing apparatus according to a first embodiment of the present invention will be described. The apparatus comprises an optical disc 101, a pickup 102 for performing recording/reproduction of data of the optical disc 101, and a spindle motor 103 for rotating the optical disc. Designated by 104 is a servo for controlling the pickup 102 and the spindle motor 103 and by 105 is a laser driver (Laser Diode Driver; hereinafter referred to as LDD) and by 106 is an analog front end (hereinafter referred to as AFE) for applying an analog process to an analog reproduction signal read out of the optical disc 101 through the pickup 102. A read channel 107 performs a waveform equalizing process, binary-digitization and synchronizing clock generation. A modem circuit 108 performs a modem process, a RAM control circuit 109 controls the access to a RAM 111 from individual circuits and an error correction circuit 110 adds an error correction code during recording and corrects errors during reproduction. An input/output circuit 112 controls the access to an external host 113 and a microcomputer 114 controls the system. An authentication circuit 115 performs apparatus authentication in relation with the external host and a bus encryption circuit 116 encrypts input/output data to/from the host 113.

Operation of the data recording/reproducing apparatus shown in FIG. 1 will now be described. Firstly, a recording process in FIG. 1 will be explained by using a RAM access timing diagram of FIG. 2A. Illustrated in FIG. 2A are RAM access times in a unit of one cluster (in the LDC cluster of Blu-ray, 32 sectors) in the course of encoding of user data, with “A”, “B”, “C” and “D” in the figure designating different clusters. Upon start of a recording process, apparatus authentication between the recording/reproducing apparatus and the host 113 is first carried out. The authentication circuit 115 authenticates that the recording/reproducing apparatus is a normal apparatus which is granted a license for dealing with host 113 in encrypted exchange therewith and by creating a common key through the use of information specified to the recording/reproducing apparatus and information specified to the disc 101 and permitting the apparatus and the host to share the key, encryption/decryption can be allowed to proceed. Since the apparatus authentication can be determined by a combination of the recording/reproducing apparatus, host 113 and optical disc 101, it may be practiced not upon start of recording but in initialization operation when the optical disc 101 is inserted to the recording/reproducing apparatus. Recording data in a unit of sector received from the host 113 is inputted as data encrypted with the common key or original data not subject to encryption, along with information about the presence/absence of encryption and recorded on the RAM 111 through the input/output circuit 112 and RAM control circuit 109 (201). The information concerning the presence/absence of encryption is stored in, for example, part of user control data as flag information and similarly it is inputted from the host 113 and recorded on the RAM 111 at an area different from that of the recording data, so that the flags can be read to provide switching information in a unit of sector. Subsequently, in accordance with the information concerning the presence/absence of encryption, the recording data on the RAM 111 undergoes a process for decryption and is again recorded on the RAM 111. Here, the key used during decryption is the same as that previously obtained during authentication between the host 113 and the authentication circuit 115 and by using this key, the bus encryption circuit 116 applies a decryption process to encrypted data and a return process to not encrypted data so as to give nothing to it (202). Thereafter, following the rule of encoding, the error correction circuit 110 performs a scramble process and an error correction code addition process (203) and the modem circuit 108 performs a modulation process (204), thus delivering the resulting data externally. The thus created encoded recording data is recorded on the optical disc 101 through the LDD 105 and pickup 102. As shown in FIG. 2A, the processes including the input process 201 by the input/output circuit 112, the decryption process 202 by the bus encryption circuit 116, the error correction code addition process 203 by the error correction circuit 110 and the modulation process 204 by the modem circuit 108 are each carried out in a pipe-line fashion in a unit of cluster on the time series basis and by switching the presence/absence of the decryption process inside the bus encryption circuit 116 in accordance with the information concerning the presence/absence of encryption, the access to the memory can be controlled with ease.

Next, a reproduction process in FIG. 1 will be described using a RAM access timing diagram of FIG. 2B. Similarly to the case of the recording process, the apparatus authentication between the recording/reproducing apparatus and the host 113 is carried out, so that the authentication circuit 115 is assumed to have a key the host 113 shares. Reproduction data read out of the optical disc 101 through the pickup 102 is subjected to the analog process, waveform equalizing process and binary-digitization process in the AFE 106 and read channel 107 and then inputted to the modem circuit 108. In the modem circuit 108, the resulting data is applied with a demodulation process and recorded on the RAM 111 through the RAM control circuit 109 (205). Subsequently, the reproduction data on the RAM 111 is read and subjected to an error correction operation and an erroneous portion is overwritten on the RAM 111 to complete a correction process (206). Further, in accordance with flag information stored in the user control data similarly read out of the disc 101, that is, information concerning the presence/absence of encryption in a unit of sector, the data is encrypted in a unit of predetermined data in the bus encryption circuit 116 (207) and delivered, along with information about the presence/absence of encryption, to the host 113 through the input/output circuit 112. In the case of the presence of encryption, the host 113 performs decryption by using the common key, thus acquiring predetermined data. As shown in FIG. 2B, the processes including the demodulation process 205 by the modem circuit 108, the error correction process 206 by the error correction circuit 110, the encryption process 207 by the bus encryption circuit 116 and the output process 208 by the input/output circuit 112 are each carried out in a pipe-line fashion in a unit of cluster on the time series basis and by switching the presence/absence of encryption process inside the bus encryption circuit 116 in accordance with the information concerning the presence/absence of encryption, the access to the memory can be controlled with ease.

As described above, in the present embodiment, the data recording/reproducing apparatus capable of inputting/outputting data encrypted in the interface to the host 113 can be provided. This can be materialized by adding to the conventional recording/reproducing apparatus the bus encryption circuit 116 and by controlling the access to the memory and through the data encryption between the recording/reproducing apparatus and the host 113, data and contents recorded on the optical disc 101 can be protected.

While in the present embodiment the data recorded on the disc 101 is described as being not limitative in particular but even in the case of the recorded data per se being encrypted pursuant to a predetermined rule, the apparatus of this invention can be materialized and by further encrypting the data bus with a view to performing double protection during transfer of the encrypted contents data between the recording/reproducing apparatus and the host, stability of the contents can be promoted further.

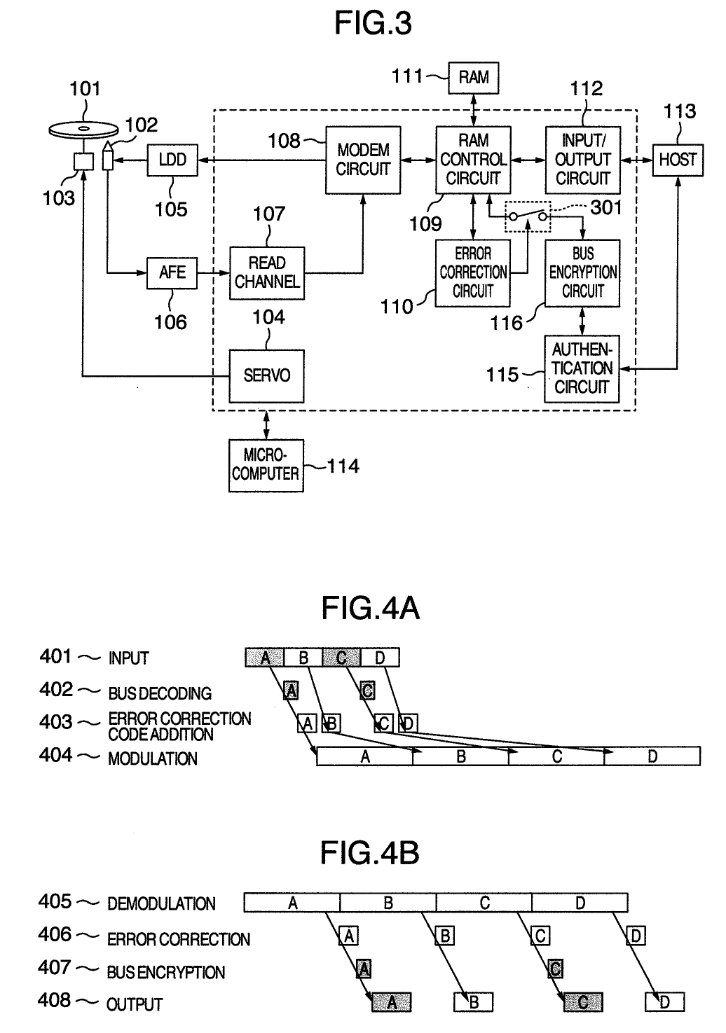

Turning to FIG. 3, a data recording/reproducing apparatus according to a second embodiment of the present invention will be described. The second embodiment differs from the FIG. 1 embodiment in that a transfer switch 301 for switching the memory access from the bus encryption circuit 116 is added and the rest is the same. In the present embodiment, the access from the bus encryption circuit 116 to the RAM 111 is limited in accordance with information about the presence/absence of encryption.

Operation of the data recording/reproducing apparatus shown in FIG. 3 will now be described by making reference to RAM access timing diagrams of FIGS. 4A and 4B. In the case of a recording process, from the host 113 undergoing apparatus authentication and sharing common key information, either data encrypted with the common key or original data not encrypted is inputted along with the information about the presence/absence of encryption and is then recorded on the RAM 111 through the input/output circuit 112 and RAM control circuit 109 (401). Subsequently, in accordance with the information about the presence/absence of encryption, the process by the bus encryption circuit 116 is switched. Assumptively, in an example of FIG. 4A, hatched cluster data (“A” or “C” in FIG. 4A) is encrypted at least one sector and the rest (“B” or “D” in FIG. 4A) is not encrypted at any one sector. For the cluster data having encrypted sectors (“A” or “C” in FIG. 4A), the bus encryption circuit 116 reads sector data required of decryption process in sector unit out of the RAM 111 and decrypts them with the key information the authentication circuit 115 has and the decrypted data is again recorded on the RAM 111 (402) and thereafter, the error correction circuit 110 executes error correction code addition (403). On the other hand, for the cluster data having no sector encrypted (“B” or “D” in FIG. 4A), execution of decryption process is not necessary and therefore, the error correction circuit 110 adds error correction code to the original data inputted from the input/output circuit 112 (403). The process by the bus encryption circuit 116 is switched by transferring the transfer switch 301 through the use of the information about the presence/absence of encryption present in the user control data. Finally, the data added with the error correction code is subjected to the modulation process by the modem circuit 108 so as to be delivered as recording data (404) which in turn is recorded on the optical disc 101 through the LDD 105 and pickup 102. Similarly, in the case of a reproduction process, the presence/absence of the process by the bus encryption circuit 116 is also switched in accordance with the information about the presence/absence of encryption. In the case of the cluster data having in one cluster a sector required of encryption (“A” or “C” in FIG. 4B), for binary data inputted from the optical disc 101 through the pickup 102, AFE 106 and read channel 107, only sector data required of the demodulation process by the modem circuit 108 (405), the correction process by the error correction circuit 110 (406) and the encryption is read out which in turn is applied with the encryption process by the bus encryption circuit 116 (407). Thereafter, the reproduction data recorded on the RAM 111 is delivered to the host 113 by means of the input/output circuit 112 (408). Here, the encryption process by the bus encryption circuit 116 is carried out by using the key information owned by authentication circuit 115 which is authenticated between the host 113 and the recording/reproducing apparatus and the encrypted data inputted to the host 113 can be decrypted by using the shared key information, thus providing original data. On the other hand, in the case of the cluster data having in one cluster no sector required of encryption (“B” or “D” in FIG. 4B), inputted binary data is applied with the demodulation process (405) and the error correction process (406) as well and the resulting data is delivered to the host 113 by means of the input/output circuit 112 (408).

As described above, in the present embodiment, the data recording/reproducing apparatus capable of performing input/output of encrypted data to/from the host 113 can be provided and besides, for data not required of encryption, the access to the RAM 111 by the encryption/decryption process can be eliminated, thereby ensuring that the data processing speed can be increased.

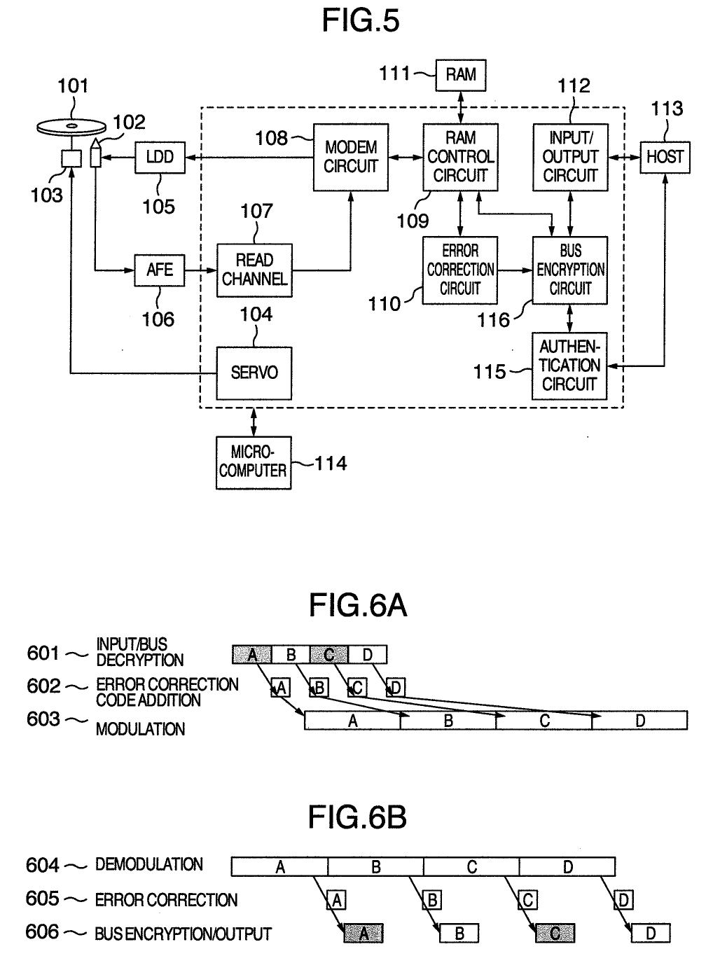

Turning to FIG. 5, a data recording/reproducing apparatus according to a third embodiment of the present invention will be described. The third embodiment is the same as the FIG. 1 embodiment with only exception that the input/output data to/from the input/output circuit 112 is not from the RAM control circuit 109 but is routed through the bus encryption circuit 116.

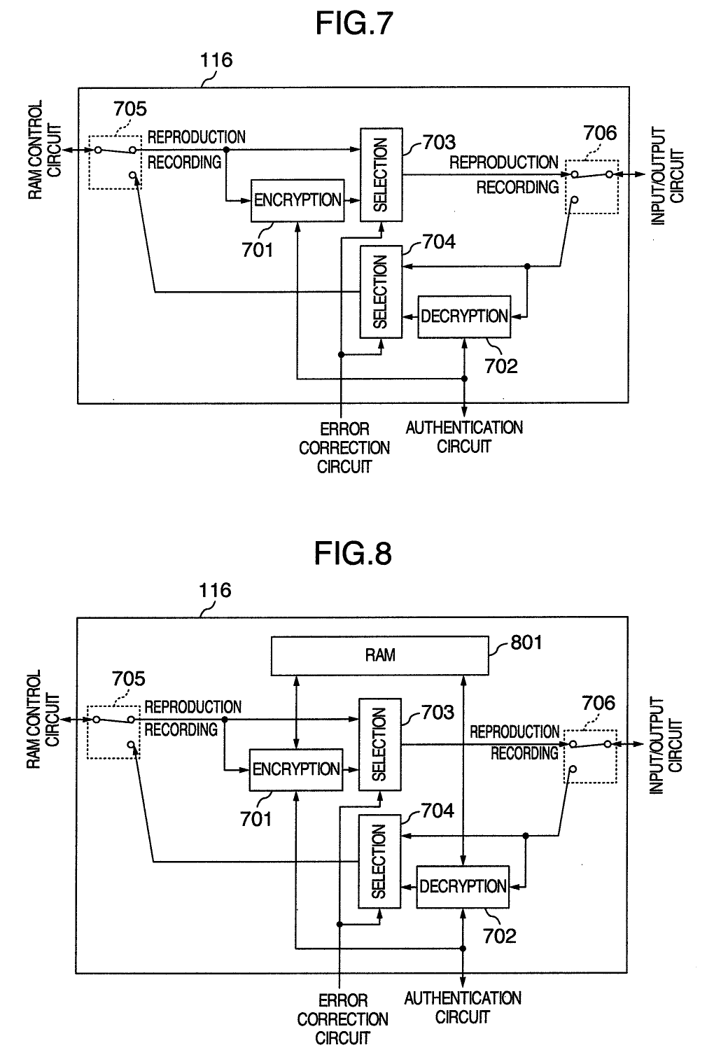

Operation of the data recording/reproducing apparatus shown in FIG. 5 will now be described by using RAM access timing diagrams of FIGS. 6A and 6B. In the case of a recording process, for recording data inputted from the host 113 to the input/output circuit 112, data encrypted in the bus encryption circuit 116 in accordance with information about the presence/absence of encryption inputted separately is subjected to the decryption process and recorded on the RAM 111 through the RAM control circuit 109, with data not encrypted recorded as it is on the RAM 111 through the RAM control circuit 109 (601). The bus encryption circuit 116 is illustrated schematically in FIG. 7. As will be seen at the path for recording in FIG. 7, there is provided a circuit 704 for selection of a path associated with a decryption circuit 702 adapted to perform decryption by using key information the authentication circuit 115 has and a path from the input/output circuit 112, and the paths are switched in accordance with information about the presence/absence of encryption to deliver data to the RAM control circuit 109. Subsequently, recording data recorded on the RAM 111 and subject to decryption is applied with the error correction code addition process by the error correction circuit 110 (602) and the modulation process by the modem circuit 108 (603) and then recorded on the optical disc 101 through the LDD 105 and pickup 102. Similarly, in the case of a reproduction process, binary data inputted from the optical disc 101 through the pickup 102, AFE 106 and read channel 107 is applied with the demodulation process by the modem circuit 108 (604) and the error correction process by the error correction circuit 110 (605). Thereafter, for reproduction data read out of the RAM 111, the data is encrypted at a necessary sector by the bus encryption circuit 116 and then delivered, along with information about the presence/absence of encryption, to the host 113 through the input/output circuit 112 (606). As will be seen at the path for reproduction in FIG. 7, there is provided a circuit 703 for selection of a path associated with an encryption circuit 701 adapted to perform encryption by using key information the authentication circuit 115 has and a path from the RAM control circuit 109, and the paths are switched in accordance with information about the presence/absence of encryption to deliver data to the input/output circuit 112.

The data recording/reproducing apparatus according to the third embodiment of the invention (FIG. 5) has been described as using the encryption circuit 116 of FIG. 7 but it can also be constructed similarly by using a bus encryption circuit 116 as shown in FIG. 8. The FIG. 8 example differs from the FIG. 7 example in that the bus encryption circuit 116 incorporates a RAM 801 dedicated thereto and arithmetic operations during encryption and decryption of data are executed by way of the RAM 801. Since the recording/reproducing apparatus is constructed by using the RAM 801 separate from the RAM 111 used for error correction, the processing time can be substantially the same as that of the access to the RAM 111 in the conventional data recording/reproducing apparatus and thanks to the provision of the RAM 801 dedicated to encryption/decryption, somewhat sophisticated operation can be dealt with easily.

As described above, in the present embodiment, the data recording/reproducing apparatus capable of performing input/output of encrypted data to/from the host 113 can be provided and besides, because the access to the RAM 11 is shared by the input/output circuit 112 and the bus encryption circuit 116, the processing time which is substantially the same as the access time to the RAM 111 in the conventional data recording/reproducing apparatus can be achieved.

Conceivably, in another embodiment, an optical disc apparatus connectable to a host comprises a pickup for reading modulated data from an optical disc, a demodulation circuit for demodulating the modulated data read out of the pickup, an error correction process circuit for correcting for errors the data demodulated by the demodulation circuit, an encryption circuit for encrypting the data corrected for errors by the error correction process circuit, and an output circuit for outputting the data encrypted by the encryption circuit to the host, wherein the demodulation circuit, the correction process circuit and the encryption circuit performs the processes by using the same memory.

Conceivably, in still another embodiment, an optical disc apparatus connectable to a host comprises a pickup for reading encrypted and modulated data from an optical disc, a demodulation circuit for demodulating the encrypted and modulated data read out by the pickup, an error correction process circuit for correcting for errors the data demodulated by the demodulation circuit, an encryption circuit for further encrypting the data corrected for errors by the error correction process circuit, and an output circuit for outputting data further encrypted by the encryption circuit to the host, wherein the demodulation circuit, the correction process circuit and the encryption circuit carry out the processes by using the same memory.

Furthermore, the aforementioned optical disc apparatus may further comprise an authentication circuit for performing authentication in relation with the host, wherein data encrypted by the encryption circuit is delivered to the host authenticated by the authentication circuit.

It should be further understood by those skilled in the art that although the foregoing description has been made on embodiments of the invention, the invention is not limited thereto and various changes and modifications may be made without departing from the spirit of the invention and the scope of the appended claims.

1. A data recording/reproducing apparatus for recording/reproducing data on/from an optical disc when the data is partitioned in a unit of h bytes (h: natural number), added with an identification address or an error detection code to form a sector, added with an error correction code in a unit of i sectors (i: natural number) to form a block, divided into data in a unit of j bytes (j: natural number) and added with a synchronizing code to form a frame and the frame data is modulated, said data being encrypted in a unit of sector pursuant to a predetermined rule and inputted/outputted to/from a host computer, comprising:
temporary storage means for storing the data temporarily;
input means for recording the inputted data on said temporary storage means;
data decryption means for reading encrypted data inputted to said temporary storage means to decrypt said data and again writing decrypted data on said temporary storage means;
error correction code addition means for reading the decrypted data to perform an error correction code operation and add said data with an error correction code and for writing the resulting data; and
modulation means for modulating said data added with the error correction code pursuant to a modulation rule.

2. A data recording/reproducing apparatus according to claim 1, wherein along with said encrypted data, information about the presence/absence of encryption is also inputted in a unit of sector and said data decryption means switches, in accordance with the information about the presence/absence of encryption, the operation of decryption process applied to the data read out of said temporary storage means.

3. A data recording/reproducing apparatus for recording/reproducing data on/from an optical disc when the data is partitioned in a unit of h bytes (h: natural number), added with an identification address or an error detection code to form a sector, added with an error correction code in a unit of i sectors (i: natural number) to form a block, divided into data in a unit of j bytes (j: natural number) and added with a synchronizing code to form a frame and the frame data is modulated, said data being encrypted in a unit of sector pursuant to a predetermined rule and inputted/outputted to/from a host computer, comprising:
temporary storage means for storing said data temporarily;
demodulation means for demodulating data read out of said optical disc in accordance with a modulation rule and recording it on said temporary storage means;
error correction means for reading the demodulated data to perform an error correction code operation and correcting the read data by replacing it with modified data;
data encryption means for reading the data corrected for errors to encrypt it and again writing the encrypted data in said temporary storage means; and
output means for outputting said encrypted data.

4. A data recording/reproducing apparatus according to claim 3, wherein along with said encrypted data, information about the presence/absence of encryption is also inputted in a unit of sector and said data encryption means switches operation of encryption process for data read out of said temporary storage means in accordance with the information about the presence/absence of encryption.

5. A data reproducing apparatus wherein the data recording/reproducing apparatus as recited in claim 1 or 3 and a host computer connectable thereto each comprises authentication means for mutual authentication to create a common key, and said encryption means and said decryption means perform operations of the encryption process and decryption process by using the common key created by said authentication means.

6. A data recording/reproducing apparatus for recording/reproducing data on/from an optical disc when the data is partitioned in a unit of h bytes (h: natural number), added with an identification address or an error detection code to form a sector, added with an error correction code in a unit of i sectors (i: natural number) to form a block, divided into data in a unit of j bytes (j: natural number) and added with a synchronizing code to form a frame and the frame data is modulated, said data being encrypted in a unit of sector pursuant to a predetermined rule and inputted/outputted to/from a host computer, comprising:
temporary storage means for storing the data temporarily;
input means for recording the inputted data on said temporary storage means;
data decryption means for reading encrypted data inputted to said temporary storage means to decrypt said data and for again writing decrypted data on said temporary storage means;
error correction code addition means for reading the decrypted data to perform an error correction code operation and add said data with an error correction code and for writing the resulting data; and
modulation means for modulating said data added with the error correction code pursuant to a modulation rule,
wherein along with said encrypted data, information about the presence/absence of encryption in a unit of sector is also inputted and said data decryption means reads, for only a sector detected as being encrypted in accordance with the encryption presence/absence information, data from said temporary storage means and performs operation.

7. A data recording/reproducing apparatus for recording/reproducing data on/from an optical disc when the data is partitioned in a unit of h bytes (h: natural number), added with an identification address or an error detection code to form a sector, added with an error correction code in a unit of i sectors (i: natural number) to form a block, divided into data in a unit of j bytes (j: natural number) and added with a synchronizing code to form a frame and the frame data is modulated, said data being encrypted in a unit of sector pursuant to a predetermined rule and inputted/outputted to/from a host computer, comprising:
temporary storage means for storing said data temporarily;
demodulation means for demodulating data read out of said optical disc pursuant to a modulation rule and recording the data on said temporary storage means;
error correction means for reading the demodulated data to perform an error correction code operation and correcting the read data by replacing it with modified data;
data encryption means for reading the data corrected for errors and encrypting it and then again writing the encrypted data in said temporary storage means; and
output means for outputting said encrypted data,
wherein along with the encrypted data, information about the presence/absence of encryption in a unit of sector is also outputted and said data encryption means reads, for only a sector detected as being encrypted in accordance with the encryption presence/absence information, data from said temporary storage means and performs operation.

8. A data recording/reproducing apparatus for recording/reproducing data on/from an optical disc when the data is partitioned in a unit of h bytes (h: natural number), added with an identification address or an error detection code to form a sector, added with an error correction code in a unit of i sectors (i: natural number) to form a block, divided into data in a unit of j bytes (j: natural number) and added with a synchronizing code to form a frame and the frame data is modulated, said data being encrypted in a unit of sector pursuant to a predetermined rule and inputted/outputted to/from a host computer, comprising:
temporary storage means for storing said data temporarily;
data decryption means for decrypting encrypted input data and recording it on said temporary storage means;
error correction code addition means for reading the decrypted data to perform an error correction code operation and add said data with an error correction code and for writing the resulting data; and
modulation means for modulating said data added with the error correction code pursuant to a modulation rule.

9. A data recording/reproducing apparatus according to claim 8, wherein said data decryption means includes selection means for switching the inputted data and the data as a result of data decryption of said input data, and along with said encrypted data, information about the presence/absence of encryption in a unit of sector is also inputted to control said selection means in accordance with the encryption presence/absence information.

10. A data recording/reproducing apparatus for recording/reproducing data on/from an optical disc when the data is partitioned in a unit of h bytes (h: natural number), added with an identification address or an error detection code to form a sector, added with an error correction code in a unit of i sectors (i: natural number) to form a block, divided into data in a unit of j bytes (j: natural number) and added with a synchronizing code to form a frame and the frame data is modulated, said data being encrypted in a unit of sector pursuant to a predetermined rule and inputted/outputted to/from a host computer, comprising:
temporary storage means for storing said data temporarily;
demodulation means for demodulating data read out of said optical disc pursuant to a modulation rule and recording the data on said temporary storage means;
error correction means for reading the demodulated data to perform an error correction code operation and correcting the read data by replacing it with modified data; and
data encryption means for reading the data corrected for errors, encrypting said data and outputting the encrypted data.

11. A data recording/reproducing apparatus according to claim 10, wherein said data encryption means includes selection means for switching the error-corrected data to be outputted and the data as a result of data encryption of said error-corrected data, and along with said encrypted data, information about the presence/absence of encryption in a unit of sector is also outputted to control said selection means in accordance with the encryption presence/absence information.

12. A data recording/reproducing apparatus according to claim 9 or 11, wherein said data decryption means as recited in claim 9 or said data encryption means as recited in claim 11 includes second temporary storage means for storing the data temporarily when operation of data encryption and decryption is carried out.

13. An optical disc apparatus connectable to a host, comprising:
a pickup for reading modulated data from an optical disc;
a demodulation circuit for demodulating the modulated data read by said pickup;
an error correction process circuit for correcting the data demodulated by said demodulation circuit for errors;
an encryption circuit for encrypting the data corrected for errors by said error correction process circuit; and
an output circuit for outputting the data encrypted by said encryption circuit to the host,
wherein said demodulation circuit, said correction process circuit and said encryption circuit perform the processes by using the same memory.

14. An optical disc apparatus connectable to a host, comprising:
a pickup for reading encrypted and modulated data from an optical disc;
a demodulation circuit for demodulating the encrypted and modulated data read by said pickup;
an error correction process circuit for correcting the data demodulated by said demodulation circuit for errors;
an encryption circuit for further encrypting the data corrected for errors by said error correction process circuit; and
an output circuit for outputting the data further encrypted by said encryption circuit to the host,
wherein said demodulation circuit, said correction process circuit and said encryption circuit perform the processes by using the same memory.

15. An optical disc apparatus according to claim 13 or 14, further comprising an authentication circuit for performing authentication in relation with said host, wherein the data encrypted by said encryption circuit is outputted to said host authenticated by said authentication circuit.
